(19) United States
(12) Patent Application Publication
(10) Pub. No.: US 2014/0310314 A1
(43) Pub. Date: Oct. 16, 2014

(54) MATCHING PERFORMANCE AND COMPRESSION EFFICIENCY WITH DESCRIPTOR CODE SEGMENT COLLISION PROBABILITY OPTIMIZATION

(71) Applicant: Samsung Electronics Co., Ltd., Suwon-si (KR)

(72) Inventors: Zhu Li, Plano, TX (US); Abhishek Nagar, Garland, TX (US); Gaurav Srivastava, Dallas, TX (US); Felix Carlos Fernandes, Plano, TX (US)

(73) Assignee: Samsung Electronics Co., Ltd., Suwon-si (KR)

(21) Appl. No.: 14/249,929

(22) Filed: Apr. 10, 2014

Related U.S. Application Data
(60) Provisional application No. 61/812,307, filed on Apr. 16, 2013.
(60) Provisional application No. 61/812,999, filed on Apr. 17, 2013.

(51) Int. Cl. G06F 17/30

(52) U.S. Cl. CPC G06F 17/30256
USPC 707/780

(57) ABSTRACT

A method and apparatus include extracting a global descriptor from a query image with a plurality of segments. The method also includes identifying segments with a desirable discriminating potential by analyzing data of the plurality of segments based on an available image database. The method also includes creating a bitmask where the identified segments are active. The method also includes masking any segment of the plurality of segments of the global descriptor that are inactive according to the bitmask

A method includes extracting a global descriptor from a query image and identifying one or more reference global descriptors. The method also includes determining a distance between the global descriptor and each of the one or more reference global descriptors. In addition, the method includes, responsive to the distance satisfying a threshold, adding an image associated with each of the one or more reference global descriptors that satisfy the threshold to a list.

### CROSS-REFERENCE TO RELATED APPLICATION(S) AND CLAIM OF PRIORITY

This application claims priority under 35 U.S.C. §119(e) to U.S. Provisional Patent Application Ser. No. 61/812,307 filed on Apr. 16, 2013 and entitled “IMPROVING MATCHING PERFORMANCE AND COMPRESSION EFFICIENCY WITH DESCRIPTOR CODE SEGMENT COLLISION PROBABILITY OPTIMIZATION,” and U.S. Provisional Patent Application Ser. No. 61/812,999 filed on Apr. 17, 2013 and entitled “IMPROVING VISUAL DESCRIPTOR MATCHING WITH HEAT KERNEL CORRELATION MODELING.” The above-identified provisional patent applications are hereby incorporated by reference in their entirety.

### TECHNICAL FIELD

This application relates generally to visual searching and, more specifically, to improving matching performance and compression efficiency with descriptor code segment collision probability optimization.

### BACKGROUND

Visual searching typically involves two steps during “retrieval” operations: (i) using global descriptors from a query image to shortlist a set of database images and (ii) using local descriptors within a geometric verification step to calculate matching scores between the query image and the database images in the retrieved shortlist. Currently, the Motion Pictures Experts Group (MPEG) standardizes a test model for Compact Descriptors for Visual Search (CDVS) with improved performance.

### SUMMARY

In a first embodiment, a method includes extracting a global descriptor from a query image with a plurality of segments. The method also includes identifying segments with a desirable discriminating potential by analyzing data of the plurality of segments based on an available image database. The method further includes creating a bitmask where the identified segments are active. In addition, the method includes masking any segment of the plurality of segments of the global descriptor that are inactive according to the bitmask.

In a second embodiment, an apparatus includes at least one processing device configured to extract a global descriptor from a query image with a plurality of segments. The at least one processing device is also configured to identify segments with a desirable discriminating potential by analyzing data of the plurality of segments based on an available image database. The at least one processing device is further configured to create a bitmask where the identified segments are active. In addition, the at least one processing device is configured to mask any segment of the plurality of segments of the global descriptor that are inactive according to the bitmask.

In a third embodiment, a method includes extracting a global descriptor from a query image and identifying one or more reference global descriptors. The method also includes determining a distance between the global descriptor and each of the one or more reference global descriptors. In addition, the method includes, responsive to the distance satisfying a threshold, adding an image associated with each of the one or more reference global descriptors that satisfy the threshold to a list.

In a fourth embodiment, an apparatus includes at least one processing device configured to extract a global descriptor from a query image and identify one or more reference global descriptors. The at least one processing device is also configured to determine a heat kernel based weighted Hamming distance between the global descriptor and each of the one or more reference global descriptors. In addition, the at least one processing device is configured, responsive to the heat kernel based weighted Hamming distance satisfying a threshold, to add an image associated with each of the one or more reference global descriptors that satisfy the threshold to a list.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication unless explicitly specified. The terms “include” and “comprise,” as well as derivatives thereof, mean inclusion without limitation. The term “or” is inclusive, meaning “and/or.” The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical signals or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior uses as well as future uses of such defined words and phrases.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates a high-level block diagram of an example visual search system according to this disclosure;

FIG. 2 illustrates a high-level block diagram of an example querying process utilizing Compact Descriptors for Visual Search (CDVS) according to this disclosure;

FIG. 3 illustrates a high-level block diagram of an example compression system according to this disclosure;

FIG. 4 illustrates an example process for obtaining a bit mask for global descriptors according to this disclosure;

FIG. 5 illustrates an example process for masking bits of a global descriptor according to this disclosure; and

FIG. 6 illustrates an example device in a visual search system according to this disclosure.

### DETAILED DESCRIPTION

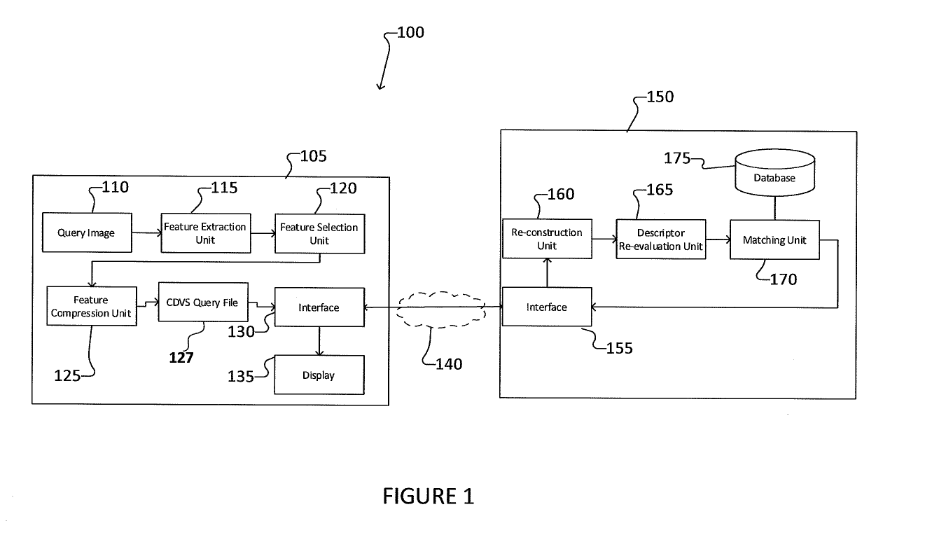

FIGS. 1 through 6, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or method.

FIG. 1 illustrates a high-level block diagram of an example visual search system 100 according to this disclosure. The visual system 100 includes components supporting feature extraction, quantization, transmission, and matching as described below. The embodiment of the visual search system 100 shown in FIG. 1 is for illustration only. Other embodiments of the visual search system 100 could be used without departing from the scope of this disclosure.

As shown in FIG. 1, the visual search system 100 includes a client device 105, a network 140, and a visual search server 150. The client device 105 generally operates to provide query data to the visual search server 150 via the network 140. After receiving the query data, the visual search server 150 implements a visual search algorithm to identify matching data to the query data.

The client device 105 represents any suitable portable device capable of communicating with the visual search server 150, such as a cellular or mobile phone or handset, smartphone, tablet, or laptop. The visual search server 150 represents any suitable computing device capable of communicating with the client device 105 via the network 140. In some instances, the visual search server 150 can include a database server storing a large number of images and a search algorithm. The network 140 includes any suitable network or combination of networks facilitating communication between different components of the system 100.

The client device 105 includes processing circuitry that implements a feature extraction unit 115, a feature selection unit 120, and a feature compression unit 125. The client device 105 also includes an interface 130 and a display 135. The feature extraction unit 115 extracts features from query images 110. The query images 110 can be captured using any suitable image capture device, such as a camera included within the client device 105. Alternatively, the client device 105 can obtain the query images 110 from another device, such as another computing device over a network.

The feature extraction unit 115 can also detect keypoints, where a keypoint refers to a region or patch of pixels around a particular sample point or pixel in image data that is potentially interesting from a geometrical perspective. The feature extraction unit 115 can then extract feature descriptors (local descriptors) describing the keypoints from the query image data. The feature descriptors can include, but are not limited to, one or more orientations, or one or more scales.

The feature extraction unit 115 forwards the feature descriptors to the feature selection unit 120. The feature selection unit 120 ranks the feature descriptors and selects some feature descriptors with higher ranks. The feature compression unit 125 compresses the selected feature descriptors, such as by performing one or more quantization processes and extraction of global descriptor. The result of such a process may be a CDVS query file 127.

The interface 130 facilitates the transmission and reception of data (such as the CDVS query file 127) over the network 140. The interface 130 represents any suitable interface capable of communicating with the visual search server 150 via the network 140. For example, the interface 130 could include a wired or wireless interface, such as a wireless cellular interface.

The display 135 can be used to present any suitable information to a user. The display 135 represents any suitable display unit capable of displaying images, such as a liquid crystal display (LCD) device, a plasma display device, a light emitting diode (LED) display device, an organic LED (OLED) display device, or any other type of display device.

The visual search server 150 includes an interface 155, processing circuitry that implements a feature re-construction unit 160 and a matching unit 170, and a database 175. The database 175 could contain a large number of images and/or videos and their feature descriptors. The interface 150 facilitates the transmission and reception of data over the network 140. The interface 150 represents any suitable interface capable of communicating with the client device 105 via the network 140.

The re-construction unit 160 decompresses compressed feature descriptors to reconstruct the feature descriptors, including local and global descriptors. The descriptor re-evaluation unit 165 re-evaluates the feature descriptors and ranks the feature descriptors based on the re-evaluation. The matching unit 170 performs feature matching to identify one or more features or objects in image data based on the reconstructed and ranked feature descriptors. The matching unit 170 can access the database 175 to perform the identification process. The matching unit 170 returns the results of the identification process to the client device 105 via the interface 155.

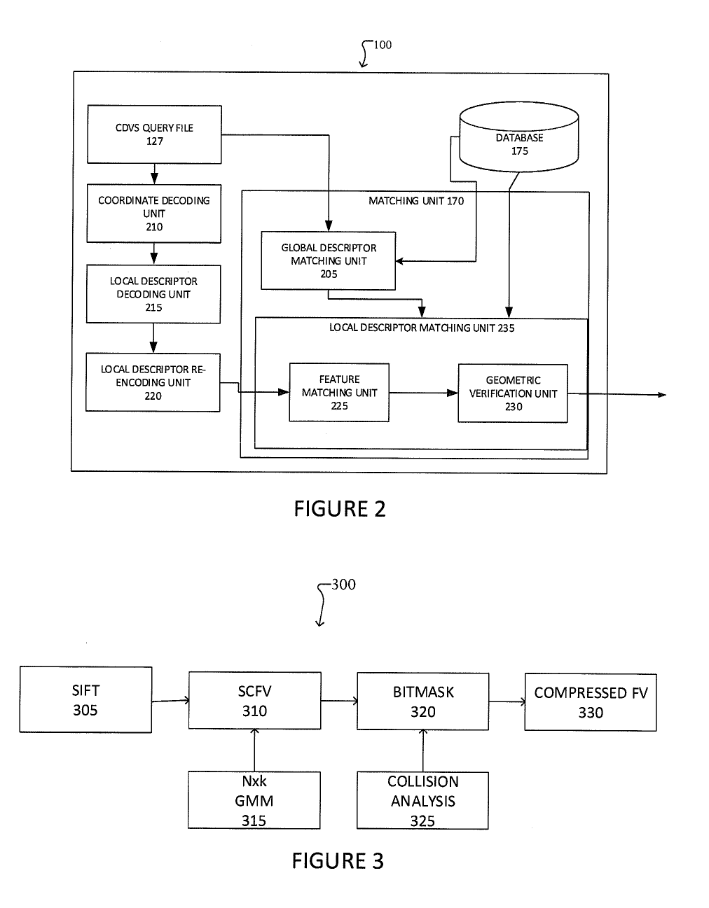

FIG. 2 illustrates a high-level block diagram of an example querying process 200 utilizing CDVS according to this disclosure. The embodiment of the querying process 200 shown in FIG. 2 is for illustration only. Other embodiments of the querying process 200 could be used without departing from the scope of this disclosure.

In some embodiments, the querying process 200 can be implemented using the processing circuitry of the visual search server 150. Here, the processing circuitry further implements a global descriptor matching unit 205, a coordinate decoding unit 210, a local descriptor decoding unit 215, and a local descriptor re-coding unit 220. The local descriptor matching unit 225 could also include a feature matching unit 225, global descriptor matching unit 205 and a geometric verification unit 230.

As noted above, the feature extraction unit 115 extracts features from query image data. In a CDVS system, visual queries include features of a Global Descriptor (GD) and a Local Descriptor (LD) with its associated coordinates. The local descriptors may be sent to the coordinate decoding unit 210, and the global descriptor may be sent to the global descriptor matching unit 205. The coordinate decoding unit 210 is configured to decode coordinates of the local descriptors, the local descriptor decoding unit 215 is configured to decode the local descriptors, and the local descriptor re-encoding unit 220 is configured to encode the local descriptors. In other embodiments, the local descriptor re-encoding unit 220 may be used only when using an orthogonal transform.

In some embodiments, in operational terminology, the LD includes a selection of Scale Invariant Feature Transform (SIFT) algorithm-based local keypoint descriptors, which are compressed through a multi-stage vector quantization (VQ) scheme. Also, in some embodiments, the GD is derived from quantizing a Fisher Vector computed from up to a predetermined number of SIFT points, which may capture the distribution of SIFT points in SIFT space. The LD contributes to the accuracy of the image matching. The GD offers the function of indexing efficiency and is used to compute a short list from a repository, which is a coarse granularity operation, for the LD-based image verification of short-listed images.

The global descriptor matching unit 205 may be configured to compare global descriptors of the query image to global descriptors of reference images. The comparison may include masking bits that are less accurate and is for shortening a list of reference images. In some embodiments, the global descriptor matching unit 205 can send a shortened list of reference descriptors to the local descriptor matching unit 235 for matching from the feature matching unit 225 and the geometric verification unit 230. The shortened list of global descriptors may be applied against the local descriptors to find matching pairs. In other embodiments, the global descriptor matching unit 205 compares segments of the global descriptor to segments from known matching and known non-matching images to analyze the value of each segment.

In particular embodiments, the GD in the CDVS may be computed as a quantized Fisher Vector using a pre-trained 128-cluster Gaussian mixture model (GMM) in SIFT space, reduced by Principle Component Analysis (PCA) to 32 dimensions. For a single image, the quantized Fisher Vector can be represented as a 128×32-bit matrix, where each row corresponds to one GMM cluster. The distance between two GDs can be computed based on the modified Hamming distances between the bit vectors corresponding to the GMM clusters that are commonly turned on for both GDs. A set of thresholds can be applied according to the sum of active clusters in both images.

In some embodiments, cluster level distance between two images can be mapped to a correlation function with the following equation:

$${S}_{X , Y} = \frac{{\sum }_{i = 1}^{128} {b}_{i}^{X} {b}_{i}^{Y} {w}_{Ha ( {u}_{i}^{X} , {u}_{i}^{Y} )} ( 32 - 2 Ha ( {u}_{i}^{X} , {u}_{i}^{Y} ) )}{32 \sqrt{{\sum }_{i = 1}^{128} {b}_{i}^{X}} \sqrt{{\sum }_{i = 1}^{128} {b}_{i}^{Y}}} \qquad ( 1 )$$

For an image pair X and Y, S is the distance between their GDs, bᵢ is one if an i^{th} Gaussian component is selected and zero otherwise, and uᵢ is a binarized Fisher sub-vector of the i^{th} Gaussian component of the GD. Also, the function Hₐ is the Hamming distance between its two parameters uᵢ^{x} and uᵢ^{y}, and W_{Ha} is a weight associated with different values of the Hamming distance Ha. The variable W can be estimated using a training datasheet. The accuracy of this equation may depend on the closeness of the training datasheet and the test datasheet.

For the image pair X and Y, their correlation can be computed as a sum of their common cluster weighted sums of Hamming distances. This solution involves a set of sixty-six parameters (thirty-three each for the mean and variance component of fisher vector) for the test model and may not be well justified.

Other embodiments of this disclosure use a heat kernel function-based correlation modeling scheme that simplifies the number of parameters from sixty-six to six while achieving modest gains in both matching and retrieval. For example, in some embodiments, the current GD in the CDVS is represented by a binary matrix of 128×32 bits, which is obtained from binarizing the first- (and second-)order Fisher Vector. The FV may be obtained by evaluating the posterior probabilities of SIFTs contained in an image with respect to a 128-component GMM in a 32-dimensional space reduced by PCA from the original 128-dimensional SIFT space. One or more embodiments provide a heat kernel function-based correlation modeling on cluster level Hamming distance, where the correlation is computed as:

w=a₁*exp(−k*h)+a₂ (2)

Replacing the correlation in Equation (1) in effect matches the input Hamming distance in the range of [0, 32] to a correlation value in the range of [a2, a1+a2]. The choice of heat kernel size k offers the flexibility of controlling the precision-recall in matching and short listing recall performance in retrieval. An optimization process can be applied to obtain the optimal parameter set for the matching and retrieval pipeline. The cluster level distance can be mapped with the following equation:

$${S}_{X , Y} = \frac{{\sum }_{i = 1}^{128} {b}_{i}^{X} {b}_{i}^{Y} ( {a}_{1} * exp ( - k * h ) + {a}_{2} )}{32 \sqrt{{\sum }_{i = 1}^{128} {b}_{i}^{X}} \sqrt{{\sum }_{i = 1}^{128} {b}_{i}^{Y}}} \qquad ( 3 )$$

where S is the distance between GDs from images X and Y, bᵢ is one if an i^{th} Gaussian component is selected and zero otherwise, h is a distance between two segments, and k is a constant. The Hamming distance in the range of [0, 32] may be mapped to a value in the range [a2, a1+a2]. A heat kernel is a monotonically decreasing convex function.

One or more embodiments provide a direct GD compression and matching scheme by analyzing the GD code segment collision probability and then computing a GD mask with this collision probability to select a subset of bits for transmission and matching. Simulation demonstrates the effectiveness of this solution in both compression and further performance gains.

FIG. 3 illustrates a high-level block diagram of an example compression system 300 according to this disclosure. The embodiment of the compression system 300 shown in FIG. 3 is for illustration only. Other embodiments of the compression system 300 could be used without departing from the scope of this disclosure.

As shown in FIG. 3, the compression system 300 includes processing circuitry that implements a Scale Invariant Feature Transform (SIFT) 305, a scalable compressed Fisher Vector (SCFV) 310, an N×K GMM 315, a bitmask 320, a collision analysis unit 325, and a compressed FV 330. To find an optimal subset of bits from the GD matrix, a collision probability analysis by the collision analysis unit 325 may be performed.

In some embodiments, a GD from the SIFT 305 is partitioned into m segments with k bits each (such as m=512 and k=8) in the SCFV 310. For each segment, histograms of Hamming distances for matching and non-matching image pairs can be obtained offline. The discriminant quality of the segment can be expressed by a D prime index, meaning the separation of means over the spread of the distances. The D prime index could be expressed as:

$$r ( i ) = \frac{{μ}_{S} - {μ}_{N}}{\sqrt{\frac{1}{2}} ( {σ}_{S}^{2} + {σ}_{N}^{2} )} \qquad ( 4 )$$

where r(i) is the D prime index, μ_{S} is a mean of a matching Hamming distances, μ_{N} is a mean of the non-matching Hamming distances, σ_{S} is a standard deviation of the matching Hamming distances, and σ_{N} is a standard deviation of the non-matching Hamming distances. The D prime index may also be referred to as the sensitivity index. In other embodiments, a simple mean Hamming distance ratio is employed. For each segment i, its distance ratio between non-matching and matching image pairs can be computed as:

$$r ( i ) = \frac{\overline{{d}_{nmp} ( l )}}{\overline{{d}_{mp} ( l )}} , \qquad ( 5 )$$

where d̅ₙ̅ₘ̅ₚ̅(̅i̅)̅ is the average Hamming distance of the i^{th} segment among the non-matching pairs of global descriptors and d̅ₘ̅ₚ̅(̅i̅)̅ is the average Hamming distance of the i^{th} segment among the matching pairs of global descriptors.

A GD mask is therefore computed at the bitmask 320 by applying a threshold t on the ratio r(i). A segment is turned on or active when r(i)>t. A segment is masked when r(i)<t. An optimization is performed for each GD bitrate to obtain the optimal threshold t* for the compressed FV 330. As an example, for a rate of 512 bits, a threshold of t*=0.95 can be selected. The resulting GD mask has 2712 active bits, which achieves a 33.79% compression of the GD while outperforming the original GD Hamming distance at higher recall ranges (>0.75). Similar performance is also achieved for t*=0.94, which has 2944 bits and achieves a 28.12% compression while also doing better in matching.

One or more embodiments also recognize and take into account that the underlying technology research for mobile visual searching and AR applications are attracting major players across the industry spectrum. The on-going MPEG standardization effort on CDVS is the main venue for visual searching and AR technology enabler research. One or more embodiments provide an improved matching accuracy.

In FIGS. 1 through 3, various units and modules are shown. Each of these units and modules includes hardware or a combination of hardware and software/firmware instructions. Each unit or module could be implemented using its own hardware, or the same hardware can be used to implement multiple units or modules.

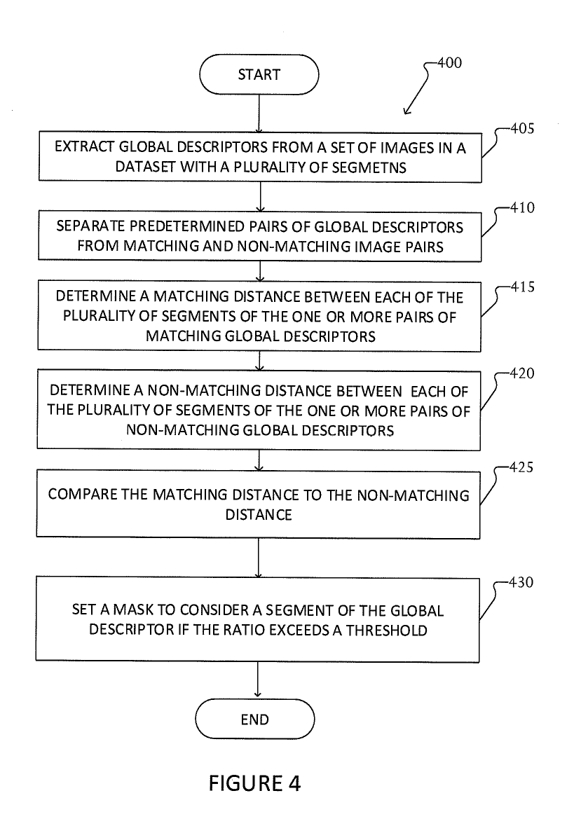

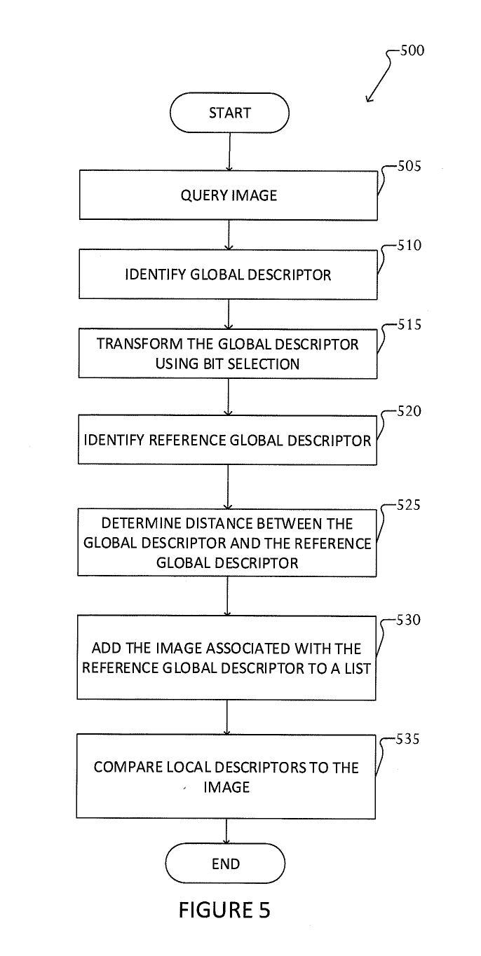

FIG. 4 illustrates an example process 400 for obtaining the bit mask for global descriptors according to this disclosure. For ease of explanation, the process 400 is described with respect to the matching unit 170 and the feature extracting unit 115. The embodiment of the method 400 shown in FIG. 4 is for illustration only. Other embodiments of the method 400 could be used without departing from the scope of this disclosure.

At operation 405, the feature extraction unit may extract global descriptors from a set of images in a dataset with a plurality of segments. In some embodiments, due to the large size of the global descriptor, dimensionality reduction techniques such as Linear Discriminant Analysis (LDA) or Principal Component Analysis (PCA) can be used to reduce the length of the global descriptor.

At operation 410, pairs of global descriptors from matching and non-matching image pairs are separated from a given database. These descriptors help identify which segments of the global descriptor are best suited for identifying matching images. At operation 415, the matching unit determines a matching distance between each of the plurality of segments of the one or more pairs of matching global descriptors. At operation 420, the matching unit determines a non-matching distance between each of the plurality of segments of the one or more pairs of non-matching global descriptors. In some embodiments, the non-matching distance and the matching distance are Hamming distances

At operation 425, the matching unit compares the matching distances to the non-matching distances. In some embodiments, the matching unit calculates a ratio of the average non-matching distance to the average matching distance. At operation 430, the matching unit sets the mask to consider a segment of the global descriptor if the ratio exceeds a threshold. In some embodiments, estimating the bitmask is performed at the system setup and is not required to be performed while processing every query. The bitmask may be updated if a new database of images is available.

In some embodiments, operations 415-425 can be described by the matching unit identifying segments with a desirable discriminating potential by analyzing data of the plurality of segments based on an available image database. In these embodiments, the desirable discriminating potential indicated by the threshold in operation 430. The threshold may indicate which segments are most likely to be good indicators. When creating a bitmask operation 430, only the identified segments may be set to active.

FIG. 5 illustrates an example process 500 for masking bits of a global descriptor according to this disclosure. For ease of explanation, the process 500 is described with respect to the matching unit 170 and the feature extracting unit 115. The embodiment of the method 500 shown in FIG. 5 is for illustration only. Other embodiments of the method 500 could be used without departing from the scope of this disclosure.

At operation 505, the feature extraction unit extracts a global descriptor from a query image with a plurality of segments. In some embodiments, due to the large size of the global descriptor, dimensionality reduction techniques such as LDA or PCA can be used to reduce the length of the global descriptor as described above. At operation 510, the matching unit identifies a global descriptor. The global descriptor can be a SCFV for the query image. At operation 515, the matching unit transforms the global descriptor using bit selection by eliminating or zero-ing the bits that are not active according to the mask. In some embodiments, the SCFV may be broken in 512 eight-bit segments instead of 128 32-bit segments.

At operation 520, the matching unit identifies a reference global descriptor. These reference global descriptors may be potential matches for the query image. At operation 525, the matching unit determines a distance between the global descriptor and the reference global descriptor using the global descriptor matching unit in 170. In some embodiments, the distance may be a heat kernel based weighted Hamming distance.

At operation 530, the matching unit adds the image associated with the reference global descriptor to a list if the Hamming distance satisfies a threshold. The threshold may be pre-set or dynamically set. At operation 535, once the reference global descriptors have been narrowed and added to the list, the matching unit compares the local descriptors to local descriptors of the images in the list.

In some embodiments, the method 400 is performed to identify optimal segments for comparison. After that, the method 500 uses those optimal segments to compare. However, other arrangements and processes may be used.

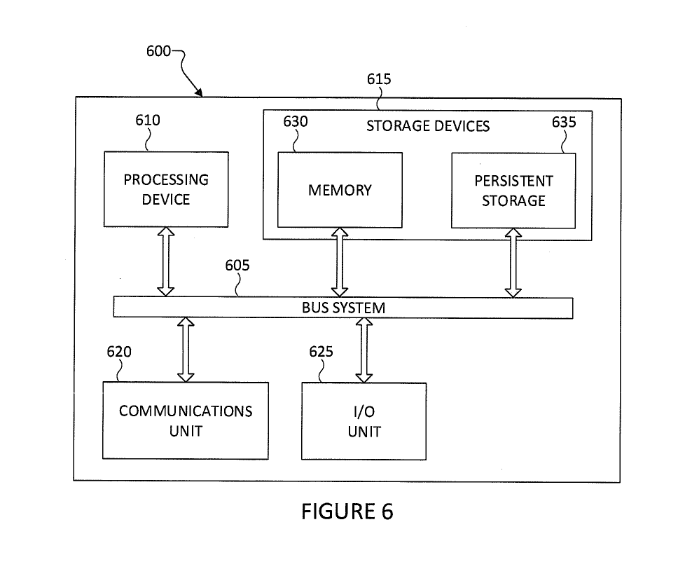

FIG. 6 illustrates an example device 600 in a visual search system according to this disclosure. The device 600 could be used as the client device 105 or the content server 150. The embodiment of the device 600 shown in FIG. 6 is for illustration only. Other embodiments of the device 600 could be used without departing from the scope of this disclosure.

As shown in FIG. 6, the device 600 includes a bus system 605, which can be configured to support communication between at least one processing device 610, at least one storage device 615, at least one communications unit 620, and at least one input/output (I/O) unit 625.

The processing device 610 is configured to execute instructions that can be loaded into a memory 630. The device 600 can include any suitable number(s) and type(s) of processing devices 610 in any suitable arrangement. Example processing devices 610 can include microprocessors, microcontrollers, digital signal processors, field programmable gate arrays, application specific integrated circuits, and discrete circuitry. The processing device(s) 610 can be configured to execute processes and programs resident in the memory 630.

The memory 630 and a persistent storage 635 are examples of storage devices 615, which represent any structure(s) capable of storing and facilitating retrieval of information (such as data, program code, or other suitable information on a temporary or permanent basis). The memory 630 can represent a random access memory or any other suitable volatile or non-volatile storage device(s). The persistent storage 635 can contain one or more components or devices supporting longer-term storage of data, such as a ready only memory, hard drive, Flash memory, or optical disc.

The communications unit 620 is configured to support communications with other systems or devices. For example, the communications unit 620 can include a network interface card or a wireless transceiver facilitating communications over the network 140. The communications unit 620 can be configured to support communications through any suitable physical or wireless communication link(s).

The I/O unit 625 is configured to allow for input and output of data. For example, the I/O unit 625 can be configured to provide a connection for user input through a keyboard, mouse, keypad, touchscreen, or other suitable input device. The I/O unit 625 can also be configured to send output to a display, printer, or other suitable output device.

It can be contemplated that various combinations or sub-combinations of the specific features and aspects of the embodiments may be made and still fall within the scope of the appended claims. For example, in some embodiments, the features, configurations, or other details disclosed or incorporated by reference herein with respect to some of the embodiments are combinable with other features, configurations, or details disclosed herein with respect to other embodiments to form new embodiments not explicitly disclosed herein. All of such embodiments having combinations of features and configurations are contemplated as being part of this disclosure. Additionally, unless otherwise stated, no features or details of any embodiments disclosed herein are meant to be required or essential to any of the embodiments disclosed herein unless explicitly described herein as being required or essential.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
extracting a global descriptor from a query image with a plurality of segments;
identifying segments with a desirable discriminating potential by analyzing data of the plurality of segments based on an available image database;
creating a bitmask where the identified segments are active; and
masking any segment of the plurality of segments of the global descriptor that are inactive according to the bitmask.

2. The method of claim 1, wherein identifying the segments with the desirable discriminating potential comprises:
identifying matching and non-matching pairs of images in the available image database
determining a matching distance between each of the plurality of segments of a set of global descriptors and a plurality of segments of one or more matching reference global descriptors of the matching pairs of images;
determining a non-matching distance between each of the plurality of segments of a set of global descriptors and a plurality of segments of the one or more non-matching reference global descriptors of the non-matching pairs of images; and
comparing the matching distance to the non-matching distance.

3. The method of claim 2, wherein comparing the matching distance to the non-matching distance comprises:
identifying a ratio r(i) defined as:
$$r ( i ) = \frac{\overline{{d}_{nmp} ( l )}}{\overline{{d}_{mp} ( l )}}$$
where d̅ₙ̅ₘ̅ₚ̅(̅i̅)̅ is an average Hamming distance of an i^{th} segment among the non-matching pairs of global descriptors, and d̅ₘ̅ₚ̅(̅i̅)̅ is an average Hamming distance of the i^{th} segment among the matching pairs of global descriptors.

4. The method of claim 2, wherein comparing the matching distance to the non-matching distance comprises:
identifying a prime sensitivity index D defined as:
$$r ( i ) = \frac{{μ}_{S} - {μ}_{N}}{\sqrt{\frac{1}{2}} ( {σ}_{S}^{2} + {σ}_{N}^{2} )}$$
where μ_{S} is a mean of matching Hamming distances, μ_{N} is a mean of non-matching Hamming distances, σ_{S} is a standard deviation of the matching Hamming distances, and σ_{N} is a standard deviation of the non-matching Hamming distances

5. The method of claim 2, wherein comparing the matching distance to the non-matching distance comprises:
calculating a ratio of the non-matching distance to the matching distance.

6. The method of claim 2, wherein the non-matching distance and the matching distance comprise Hamming distances.

7. The method of claim 1, wherein each of the one or more reference global descriptors is in a vector with segments of eight bits.

8. A method comprising:
extracting a global descriptor from a query image;
identifying one or more reference global descriptors;
determining a distance between the global descriptor and each of the one or more reference global descriptors; and
responsive to the distance satisfying a threshold, adding an image associated with each of the one or more reference global descriptors that satisfy the threshold to a list.

9. The method of claim 8, further comprising:
matching one or more local descriptors to each image in the list.

10. The method of claim 8, wherein:
the image is represented by a vector with 128 segments;
each segment is 32 bits; and
the method further comprises transforming each segment into four smaller segments of eight bits each.

11. The method of claim 8, wherein the distance between the global descriptor and each of the one or more reference global descriptors is expressed as:
$${S}_{X , Y} = \frac{{\sum }_{i = 1}^{128} {b}_{i}^{X} {b}_{i}^{Y} ( {a}_{1} * exp ( - k * h ) + {a}_{2} )}{32 \sqrt{{\sum }_{i = 1}^{128} {b}_{i}^{X}} \sqrt{{\sum }_{i = 1}^{128} {b}_{i}^{Y}}} ,$$
wherein S is the distance, bᵢ is one if an i^{th} Gaussian component is selected and zero otherwise, h is a Hamming distance between two segments, and k is a constant.

12. The method of claim 8, wherein each of the one or more reference global descriptors is in a vector with segments of eight bits.

13. An apparatus comprising:
at least one processing device configured to:
extract a global descriptor from a query image with a plurality of segments;
identify segments with a desirable discriminating potential by analyzing data of the plurality of segments based on an available image database;
create a bitmask where the identified segments are active; and
mask any segment of the plurality of segments of the global descriptor that are inactive according to the bitmask.

14. The apparatus of claim 13, wherein the at least one processing device is configured to identify the segments with the desirable discriminating potential by:
identifying matching and non-matching pairs of images in the available image database
determining a matching distance between each of the plurality of segments of a set of global descriptors and a plurality of segments of one or more matching reference global descriptors of the matching pairs of images;
determining a non-matching distance between each of the plurality of segments of a set of global descriptors and a plurality of segments of the one or more non-matching reference global descriptors of the non-matching pairs of images; and
comparing the matching distance to the non-matching distance.

15. The apparatus of claim 14, wherein the at least one processing device is configured to compare the matching distance to the non-matching distance by identify a ratio r(i) defined as:
$$r ( i ) = \frac{\overline{{d}_{nmp} ( l )}}{\overline{{d}_{mp} ( l )}}$$
where d̅ₙ̅ₘ̅ₚ̅(̅i̅)̅ is an average Hamming distance of an i^{th} segment among the non-matching pairs of global descriptors, and d̅ₘ̅ₚ̅(̅i̅)̅ is an average Hamming distance of the i^{th} segment among the matching pairs of global descriptors.

16. The apparatus of claim 14, wherein the at least one processing device is configured to compare the matching distance to the non-matching distance by identifying a prime sensitivity index D defined as:
$$r ( i ) = \frac{{μ}_{S} - {μ}_{N}}{\sqrt{\frac{1}{2}} ( {σ}_{S}^{2} + {σ}_{N}^{2} )}$$
where μ_{S} is a mean of matching Hamming distances, μ_{N} is a mean of non-matching Hamming distances, σ_{S} is a standard deviation of the matching Hamming distances, and σ_{N} is a standard deviation of the non-matching Hamming distances.

17. The apparatus of claim 14, wherein the at least one processing device is configured to compare the matching distance to the non-matching distance by calculating a ratio of the non-matching distance to the matching distance.

18. The apparatus of claim 14, wherein the non-matching distance and the matching distance comprise Hamming distances.

19. The apparatus of claim 13, wherein each of the one or more reference global descriptors is in a vector with segments of eight bits.

20. An apparatus comprising:
at least one processing device configured to:
extract a global descriptor from a query image;
identify one or more reference global descriptors;
determine a distance between the global descriptor and each of the one or more reference global descriptors; and
responsive to the distance satisfying a threshold, add an image associated with each of the one or more reference global descriptors that satisfy the threshold to a list.

21. The apparatus of claim 20, wherein the at least one processing device is further configured to:
match one or more local descriptors to each image in the list.

22. The apparatus of claim 20, wherein:
the image is represented by a vector with 128 segments;
each segment is 32 bits; and
the at least one processing device is further configured to transform each segment into four smaller segments of eight bits each.

23. The apparatus of claim 20, wherein the distance between the global descriptor and each of the one or more reference global descriptors is expressed as:
$${S}_{X , Y} = \frac{{\sum }_{i = 1}^{128} {b}_{i}^{X} {b}_{i}^{Y} ( {a}_{1} * exp ( - k * h ) + {a}_{2} )}{32 \sqrt{{\sum }_{i = 1}^{128} {b}_{i}^{X}} \sqrt{{\sum }_{i = 1}^{128} {b}_{i}^{Y}}} ,$$
wherein S is the distance, bᵢ is one if an i^{th} Gaussian component is selected and zero otherwise, h is Hamming distance between two segments, and k is a constant.

24. The apparatus of claim 20, wherein each of the one or more reference global descriptors is in a vector with segments of eight bits.
